(19) United States
(12) Patent Application Publication
(10) Pub. No.: US 2006/0081610 A1
(43) Pub. Date: Apr. 20, 2006

(54) HEATING ELEMENT OPENING ON A HOT NOZZLE

(76) Inventor: Hans-Martin Wolff, CJ-2825 Courchapoix, Jura (CH)

Correspondence Address: WHITE, REDWAY & BROWN LLP, 1217 KING STREET, ALEXANDRIA, VA, 22314, US

(21) Appl. No.: 11/163,537

(22) Filed: Oct. 21, 2005

Related U.S. Application Data
(63) Continuation of application No. PCT/EP04/04533, filed on Apr. 29, 2004.

(30) Foreign Application Priority Data
Apr. 29, 2003 (DE) 103 19 215.8

(51) Int. Cl. H05B 3/06

(52) U.S. Cl. 219/523

(57) ABSTRACT

A heating element opening arrangement for a hot nozzle arrangement is provided. The hot nozzle arrangement includes a hot nozzle including a housing and a hollow space in the housing that is to be filled with a copper solder and a heating element opening on a housing wall, and a coiled electric heating element with two ends and a metallic tubular jacket disposed in the space, both ends of the heating element extending through the heating element opening. The heating element opening arrangement includes a lead-in sleeve secured to the housing wall and comprising a lead-in bore through which an end of the heating element extends and an annular compression body comprising a thermally resistant material, the compression body being compressed against all sides of the metallic jacket of the heating element.

The present application is a continuation of PCT/EP2004/004533, filed Apr. 29, 2004, which claims priority to DE 103 19 215.8, filed Apr. 29, 2003, both of which are hereby incorporated by reference.

The invention relates to a heating element opening on a housing wall of a hot nozzle, which exhibits a hollow space that is to be filled with copper solder, which space accepts a coiled electric heating element with a metallic jacket tube, such that both ends of the heating element extend through the heating element opening.

Hot nozzles serve to inject thermoplastics into molding tools. The temperature range that must be maintained until the plastic exits the nozzle is very narrow in some plastics. For this reason, the hot nozzles must be heated as uniformly as possible down to the nozzle's tip. The coiled electric heating element, which surrounds an internal pipe of the heating jet, is therefore cast into copper solder, which is readily thermally conductive, [and] which, as a rigidified copper body, uniformly conducts the heat provided by the heating element and delivers it to the internal pipe. The copper solder can be cast in a vacuum or under protective gas (EP 0 166 919 B2).

The temperatures that occur in the course of casting lie in a range of approximately 1080-1120° C. Since the copper solder that is used is, in large measure, either pure copper or a copper alloy that flows thinly when in the castable state, an effective and temperature-resistant seal must be undertaken in the region of the heating element opening by means of the housing wall before the copper solder is poured in. In this regard, it is known how to weld a pipe that is closed by means of a cover at its outer end to a bore of the housing wall. The end of the heating element protrudes into this pipe, which is filled with a thermally resistant ceramic material. After the casting process, the closed end of the pipe is removed; the end of the heating element must then be exposed by expending considerable effort. In many cases, the heating element is damaged in the process so that the hot nozzle is unusable. Subsequent re-working after the casting process is also labor-intensive and cost-intensive; the danger of damaging the heating element in the process exists as well.

It is desirable to embody a heating element opening on a hot nozzle of the type alluded to at the outset in such a manner that a secure seal against the fluid copper solder that can be achieved by simple means is assured.

According to an aspect of the present invention, a lead-in sleeve that is tightly welded to the housing wall, exhibits, in each case, a lead-in bore through which one end of the heating element extends, and an annular compression body comprising or consisting of highly thermally resistant material is compressed on all sides against the metallic jacket pipe of the heating element.

The compression body, which causes a seal, comprises or consists of a material that tolerates, without further ado, the temperatures that occur in the casting process. As a result of the compression process, the compression body is reliably pressed against the jacket pipe of the heating element so that no fluid casting material can escape.

According to an aspect of the invention, provision is made so that the compression body is an axially flattened compression sleeve that is inserted into a conical end section of the opening bore. As a result of the deformation of this compression sleeve, which is accomplished simply by means of the exertion of an axial force, a reliable seal requiring very little space is achieved against the jacket pipe, on the one hand, and against the lead-in bore, on the other hand.

The compression body can also be a deformable compression ring, which is pressed and flattened against a stop of the lead-in bore by means of a flattening sleeve that is screwed into the lead-in bore. Even in this flattening process, an effective seal requiring very little space is achieved between the lead-in bore and the jacket pipe.

According to an aspect of the invention, provision is made so that the compression body is an annular collar that protrudes at the outer end of the lead-in bore, which annular collar is flattened tightly on all sides against the jacket pipe of the heating element. In the process, additional elements can be dispensed with. The protruding annular collar at the end of the lead-in bore comprises or consists of the material of the lead-in sleeve, which is welded to the hot nozzle's housing wall. The seal against the heating element's jacket pipe is accomplished in a simple manner by virtue of the fact that this protruding annular collar is flattened tightly on all sides against the jacket pipe.

### BRIEF DESCRIPTION OF THE DRAWINGS

In what follows, the invention is elucidated in greater detail by virtue of the embodiment examples that are depicted in the drawings. The drawings are depicted in longitudinal section in each case:

FIG. 1 depicts a hot nozzle in the cast state, not yet completely assembled, and

FIGS. 2-4 depict various embodiments of the heating element opening in enlarged partial sections, compared to FIG. 1.

### DETAILED DESCRIPTION

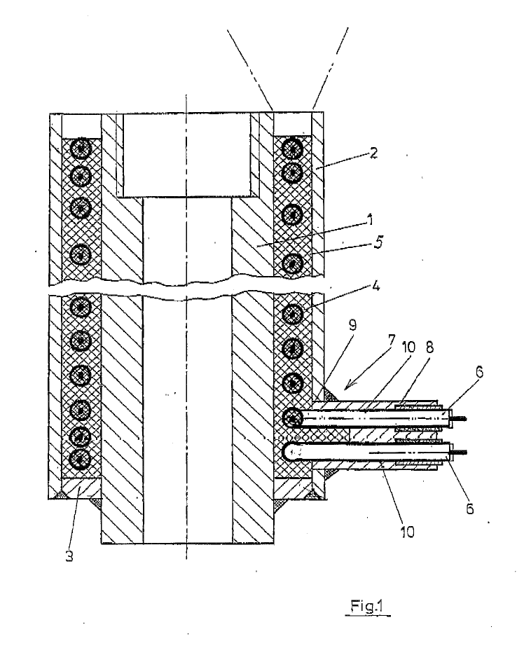

The hot nozzle depicted in FIG. 1 exhibits an internal pipe 1 that is surrounded at a distance on all sides by a housing wall 2. The inner pipe 1 and the housing wall 2 are tightly connected in the lower region of the hot nozzle by means of a bottom ring 3 that is welded in.

The hollow space remaining between the inner pipe 1 and the housing wall 2 accepts a coiled electric heating element 4, which is cast in copper solder 5.

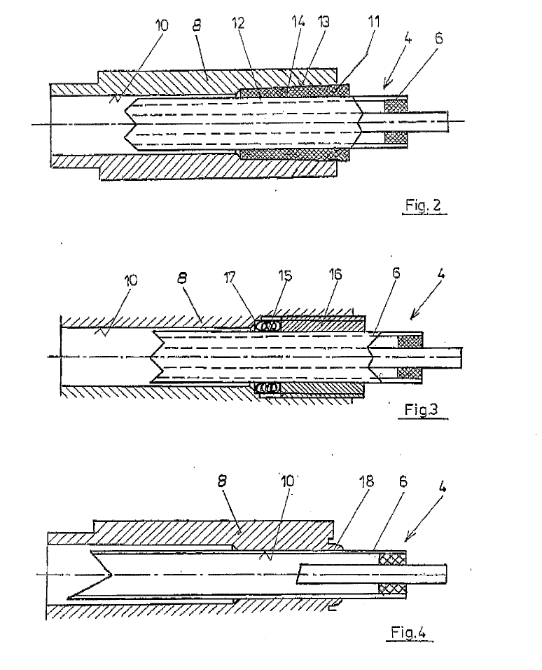

As one discerns in FIGS. 2-4 in detail, the coiled electric heating element 4 exhibits a metallic jacket pipe 6. The heating element 4 with the surrounding jacket pipe 6 is led, with both its ends, out of housing wall 2 at one heating element opening 7 in the lower area of the hot nozzle.

If the hollow space that exists between the inner pipe 1 and the housing wall 2 is filled with the copper solder 5, the heating element opening 7 must be tightly closed, otherwise, the copper solder, which flows readily, would escape. To this end, the heating element opening 7 exhibits a lead-in sleeve 8, which comprises or consists of metal and is tightly welded to the housing wall 2. The lead-in sleeve 8 extends through a bore 9 into the hot nozzle.

In the embodiment depicted in FIG. 1, the lead-in sleeve 8 exhibits two lead-in bores 10, through which, in each case, one end of heating element 4 is led out. Jacket pipe 6 of heating element 4 extends through lead-in bore 10 in the process.

The sealing of the metallic jacket pipe 6 in the allotted lead-in bore 10, occurs in each case by means of an annular compression body comprising or consisting of a highly thermally resistant material that is compressed, on all sides, against the metallic jacket pipe 6 of heating element 4.

In the embodiment depicted in FIGS. 1 and 2, the compression body comprises or consists of a compression sleeve 11 that closely surrounds the jacket pipe 6 with a cylindrical inner bore 12 and, with its slightly conical external surface 13, is inserted into a corresponding conical end section 14 of lead-in bore 10. As a result of the effects of the axial force, compression sleeve 11, which comprises or consists of metal, preferably, is flattened in such a manner that it lies against both the external surface of the jacket pipe 6 as well as the inner wall of the conical end section 14 of the lead-in bore 10 so as to create a seal.

By way of deviation from this, the compression body in the case of the embodiment according to FIG. 3 is a compression ring 15 that can undergo plastic deformation, which is pressed against a stop 17 of lead-in bore 10 by means of a flattening sleeve 16, which is screwed into the lead-in bore 10, and is flattened in the process in such a way as to create a seal against both the lead-in bore 10, as well as against the external surface of the jacket pipe 6.

The compression ring 15 can comprise or consist of various materials, so long as sufficient thermal resistance is assured, given the casting temperatures that occur. The material in question may be a ceramic material, for example, or a composite material. It is also possible, instead, to use metal that is, on the one hand, capable of plastic deformation, and on the other, resists the casting temperatures that occur.

In the case of the embodiment according to FIG. 4, the compression body is an annular collar 18 that protrudes on the outer end of lead-in bore 10, which consists of the material, preferably metal, of the lead-in sleeve 8, in a single piece. The annular collar 18 is tightly flattened on all sides against the jacket pipe 6 of heating element 4, or beaded.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A hot nozzle arrangement comprising:
a hot nozzle comprising a housing and a hollow space in the housing that is to be filled with a copper solder and a heating element opening on a housing wall;
a coiled electric heating element with two ends and a metallic tubular jacket disposed in the space, both ends of the heating element extending through the heating element opening;
a lead-in sleeve secured to the housing wall and comprising a lead-in bore through which an end of the heating element extends; and
an annular compression body comprising a thermally resistant material, the compression body being compressed against all sides of the metallic jacket of the heating element.

2. An arrangement according to claim 1, wherein the compression body is an axially flattened compression sleeve that is inserted into a conical end section of the lead-in bore.

3. An arrangement according to claim 1, wherein the compression body is a deformable compression ring adapted to be pressed and flattened against a stop of the lead-in bore by a flattening sleeve that is adapted to be screwed into the lead-in bore.

4. An arrangement according to claim 1, wherein the compression body comprises an annular collar that protrudes on an outer end of the lead-in bore and which is adapted to be flattened on all sides against the jacket pipe of the heating element.

5. A heating element opening arrangement for a hot nozzle arrangement, the hot nozzle arrangement comprising a hot nozzle comprising a housing and a hollow space in the housing that is to be filled with a copper solder and a heating element opening on a housing wall, and a coiled electric heating element with two ends and a metallic tubular jacket disposed in the space, both ends of the heating element extending through the heating element opening, the heating element opening arrangement comprising:
a lead-in sleeve secured to the housing wall and comprising a lead-in bore through which an end of the heating element extends; and
an annular compression body comprising a thermally resistant material, the compression body being compressed against all sides of the metallic jacket of the heating element.

6. A heating element opening according to claim 5, wherein the compression body is an axially flattened compression sleeve that is inserted into a conical end section of the lead-in bore.

7. A heating element opening according to claim 5, wherein the compression body is a deformable compression ring adapted to be pressed and flattened against a stop of the lead-in bore by a flattening sleeve that is adapted to be screwed into the lead-in bore.

8. A heating element opening according to claim 5, wherein the compression body comprises an annular collar that protrudes on an outer end of the lead-in bore and which is adapted to be flattened on all sides against the jacket pipe of the heating element.
